(19) United States
(12) Patent Application Publication
(10) Pub. No.: US 2009/0059459 A1
(43) Pub. Date: Mar. 5, 2009

(54) ELECTROSTATIC RECEIVING MECHANISM OF ELECTRONIC INDICATING DEVICE

(75) Inventors: Li-Sen Chen, Taoyuan Hsien (TW); Chien-Yu Hsu, Taoyuan Hsien (TW); Hui-Hsueh Chiang, Taoyuan Hsien (TW)

Correspondence Address: J C PATENTS, INC., 4 VENTURE, SUITE 250, IRVINE, CA, 92618, US

(73) Assignee: SPEED TECH CORP., Taoyuan Hsien (TW)

(21) Appl. No.: 11/848,931

(22) Filed: Aug. 31, 2007

(51) Int. Cl. H05F 3/00

(52) U.S. Cl. 361/221

(57) ABSTRACT

An electrostatic receiving mechanism of an electronic indicating device installed on the electronic indicating device and electrically connected to a grounding circuit of a circuit board is provided. The electrostatic receiving mechanism mainly includes a frame, a roller mechanism, and a supporting beam. The roller mechanism is assembled onto the frame and the frame and the roller mechanism may slide relative to each other along the guide rails of the frame, and the supporting beam is made of a metallic conductive material and electrically connected to the grounding circuit. The supporting beam has an extension arm extending towards and close to an outer edge of the roller mechanism, thereby forming an electrostatic receiving mechanism.

### BACKGROUND OF THE INVENTION

1. Field of the Invention

The present invention relates to an electrostatic receiving mechanism of an electronic indicating device, and more particularly to an electronic indicating device adapted to be installed in an electronic equipment or product to serve as a user communication interface.

2. Description of Related Art

Electrostatic discharge (ESD) is a major factor that causes damages to most of electronic elements or electronic systems under electrical overstress (EOS), which may lead to permanent damages to electronic elements and computer systems, e.g., electronic circuits. However, the occurrence of ESD damage is attributed to human factors which often cannot be avoided. In the course of manufacturing, producing, assembling, testing, storing, transporting, etc. of electronic elements or systems, static electricity is accumulated in human bodies, apparatuses, and storage equipments, and even in the electronic elements themselves. Once people put the electronic elements together in contact with one another unintentionally, a discharge path is thus formed, i.e., so-called ESD phenomenon, and thus the electronic elements or systems are damaged by ESD. The ESD not only induce fatal damages to electronic devices and degrades reliability of products, but also increases maintenance cost. Therefore, it becomes quite important to design a static electricity release mechanism or an electrostatic receiving mechanism in electronic elements or systems to release static electricity, especially for the electronic elements or systems of high precision or high economic values.

FIG. 5 shows a rotary electronic indicating device with a built-in switch disclosed in U.S. Pat. No. 6,229,103. The rotary electronic indicating device is a low-profile electronic device mounted on a circuit board, and includes an operating knob 6, a movable member 21, a base board 22, an encoder, an L-shaped actuator 24, and a grounding part 26. The operating knob 6 is fixed on the movable member 21, and the rotation axis of the operating knob 6 is about parallel to the circuit board. The movable member 21 is assembled on the base board 22, which has a drum switch 23 thereon. The movable member 21 slides linearly relative to the base board 22.

Further, the encoder includes a radial contact plate 3A and a group of elastic contact reeds 5. The radial contact plate 3A is arranged on the operating knob 6, and the elastic contact reeds 5 are insert-molded on the base board 22. The L-shaped actuator 24 has a vertical arm 24A, a horizontal arm 24B, and a holding pivot 24C. The vertical arm 24A of the L-shaped actuator 24 is adjacent to the movable member 21, the holding pivot 24C of-the L-shaped actuator 24 is arranged on the base board 22, and the L-shaped actuator 24 is placed in the linearly sliding path of the movable member 21.

The grounding part 26 is fixed on the base board 22 and includes a lightning rod 26A and a grounding contact 26B. The lightning rod 26A of the grounding part 26 is disposed between an outer edge of the operating knob 6 and the radial contact plate 3A of the encoder, and the grounding contact 26B is used to make the lightning rod 26A grounded.

When a user uses the electronic indicating device, the fingers of the user may carry static electricity sufficient enough to damage electronic apparatuses or electronic products. The electrons of static electricity may possibly produce induction or discharge phenomena with the rotary electronic indicating device transiently, which results in that the electronic apparatuses or the electronic products cause an excessive load of the circuits on the circuit board and even the overheating of the electronic apparatuses or the electronic products. In order to avoid such phenomena, the grounding part 26 disclosed in U.S. Pat. No. 6,229,103 is arranged near the place to be touched by the fingers of the user, and the grounding part 26 is connected with the grounding circuit on the circuit board. Therefore, when the fingers of the user carry static electricity, based on the principle of point discharge, the static electricity jumps to the lightning rod 26A of the grounding part 26, and then the static electricity on the lightning rod 26A is transmitted to the grounding circuit on the circuit board through the grounding contact 26B. In this way, the phenomenon that the overheating of the circuit board caused by the electrostatic induction is not likely to happen.

In the aforementioned prior art, the lightning rod 26A of the grounding part 26 must put as close to the outer edge of the navigation device as possible, i.e., near the fingers of the user. The grounding part 26 is fixed on the base board 22. Therefore, in practical manufacturing method, the grounding part 26 is inlaid on the base board 22 only by the insert molding manufacturing method. However, many uncertainties must be controlled in the insert molding manufacturing method, which may cause poor product yield. Furthermore, in this manufacturing method, a metal piece is disposed in a plastic injection mold, so that a plastic material is directly attached on the grounding part 26 during injection. As a result, the friction is generated between the metal element and the mold, which reduces the service life of the plastic mold.

Based on the aforementioned reasons, the conventional method of inlaying the grounding part 26 on the base board 22 by the insert molding manufacturing method not only causes difficulty in controlling product quality, but also easily reduces the service life of the plastic mold. Therefore, the conventional method has room for improvement.

### SUMMARY OF THE INVENTION

The present invention is mainly directed to an electrostatic receiving mechanism of an electronic indicating device without using the insert molding manufacturing method, thereby reducing the difficulty in controlling product quality and alleviating the abrasion of the plastic mold.

According to the electrostatic receiving mechanism of the electronic indicating device disclosed in the present invention, the electronic indicating device can be installed on a circuit board in an electronic apparatus or an electronic product to serve as an interface for communication between a user and the electronic apparatus or electronic product. The electrostatic receiving mechanism of the electronic indicating device mainly includes a frame, a roller mechanism, and a supporting beam. The frame has two opposite sidewalls, and at least one guide rail is disposed on the two sidewalls, respectively. The roller mechanism may be assembled on the frame, and the frame and the roller mechanism may slide relative to each other in an appropriate range along the guide rails of the frame. The supporting beam is made of a metallic conductive material, and the supporting beam is disposed on the frame and is directly or indirectly electrically connected to a grounding circuit on a circuit board. The supporting beam has an extension arm extending towards and close to an outer edge of the roller mechanism.

The saying that the supporting beam is indirectly electrically connected to the grounding circuit of the circuit board means that the supporting beam may be electrically connected to the grounding circuit of the circuit board through another medium or metal conductor instead of being directly electrically connected to the grounding circuit of the circuit board.

According to the aforementioned description, the extension arm of the supporting beam extending towards the outer edge of the roller mechanism is used to approach an electronic element or the user. Thus, based on the principle of point discharge, if the user carries static electricity, the static electricity jumps to the extension arm of the supporting beam to be transmitted to the grounding circuit of the circuit board through the supporting beam.

In the present invention, the supporting beam made of a metal material is arranged on the frame, and such arrangement is performed during the fabrication processes, so the insert molding method is not required. Therefore, the manufacturing quality of assembling the supporting beam on the frame may be easily controlled, and when an error of assembly in the production line occurs, the assembly can be detached and re-assembled without additionally consuming manufacturing molds, thereby achieving the object of the present invention.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded perspective view showing the first embodiment of the present invention.

FIG. 2 is a schematic view of an appearance of the first embodiment of the present invention after being assembled.

FIG. 3 is a bottom view showing the second embodiment of the present invention.

FIG. 3A is a schematic cross-sectional view showing the second embodiment of the present invention taken along Line A-A.

FIG. 4 is a bottom view showing the third embodiment of the present invention.

FIG. 5 is a cross-sectional view of the prior art.

### DESCRIPTION OF EMBODIMENTS

The present invention mainly relates to an electrostatic receiving mechanism of an electronic indicating device, and more particularly to an electrostatic receiving mechanism adapted to be installed in the electronic indicating device of an electronic apparatus or equipment. The electronic indicating device is a user interface which is used for the communication between a user and an electronic apparatus or equipment and is installed on a circuit board. Furthermore, the circuit board has a grounding circuit and may be electrically connected to the electrostatic receiving mechanism disclosed in the present invention, thereby sending directions or instructions of the user to the circuit board for the electronic device of the electronic apparatus or equipment to make a determination and to execute.

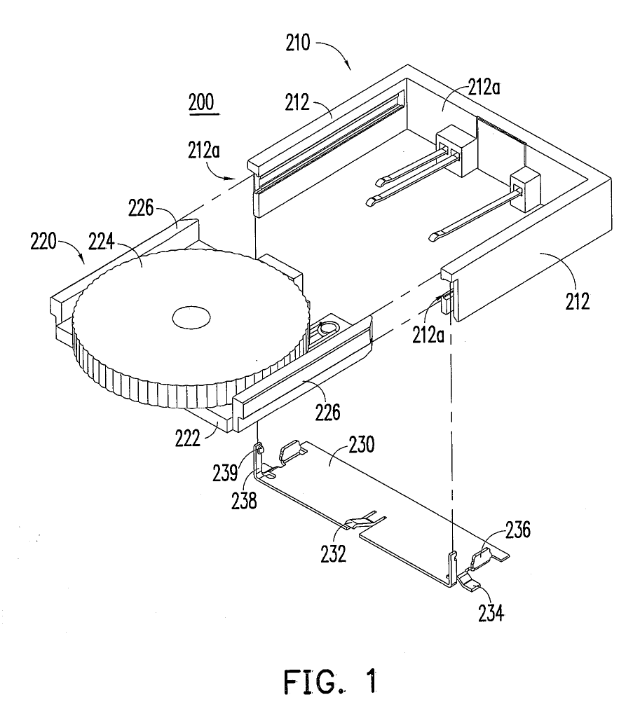

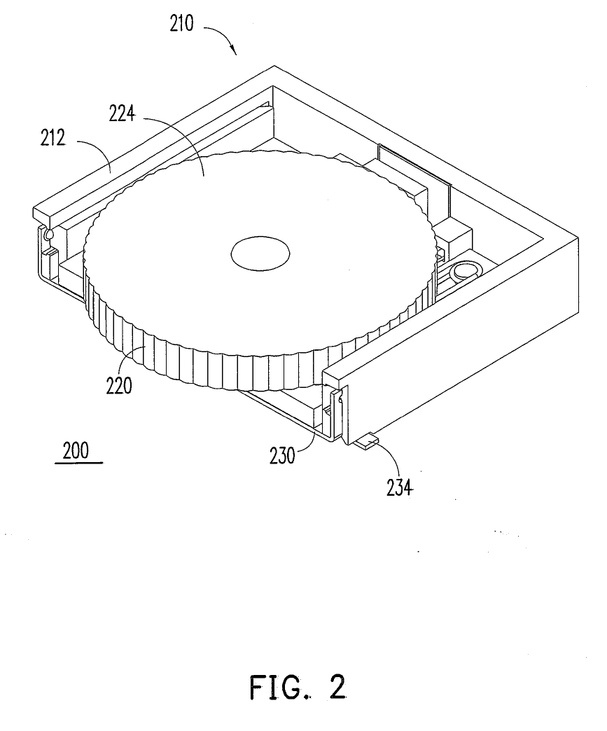

In preferred embodiments of the present invention as shown in FIGS. 1 and 2, the electrostatic receiving mechanism 200 of the electronic indicating device is mainly composed of a frame 210, a roller mechanism 220, and a supporting beam 230. The frame 210 has two opposite sidewalls 212 substantially in parallel, and the sidewalls 212 each have a guide rail 212a. The roller mechanism 220 is assembled on the frame 210, and the frame 210 and the roller mechanism 220 slide relative to each other along the guide rails 212a of the frame 210. In this embodiment, the frame 210 is fixed on the circuit board (not shown) of the electronic apparatus or equipment, so the relative sliding means that the roller mechanism 220 slides in an appropriate range along the guide rails 212a of the frame 210. Those skilled in the art may make changes easily, such as (but not limited to), fixing the roller mechanism 220 to make the frame 210 to slide in the appropriate range by using the guide rails 212a.

The supporting beam 230 is made of a metallic conductive material and electrically connected to the grounding circuit on the circuit board. The supporting beam 230 is assembled on the frame 210, and has at least one grounding contact 234 which is electrically connected to the grounding circuit on the circuit board. The supporting beam 230 has an extension arm 232 extending towards the outer edge of the roller mechanism 220, such that a tip end of the extension arm 232 approaches the outer edge of the roller mechanism 220.

In detail, the roller mechanism 220 includes a sliding base 222, a roller 224, and a flange 226. The sliding base 222 can be movably arranged in the frame 210, and the roller 224 is arranged on the sliding base 222. Furthermore, the roller 224 may rotate substantially in parallel to the sliding base 222. The flange 226 is connected with two opposite sides of the sliding base 222, respectively, and is suitable for moving along the guide rails 212a, such that the sliding base 222 can get into the frame 210 or depart from the frame 210.

In view of the above, when getting close to the electronic apparatus or equipment, the user approaches to the outer edge of the roller mechanism 220 of the electronic indicating device, and meanwhile the user also approaches the supporting beam 230 of the electronic apparatus or equipment, so the static electricity carried by the user may easily jump to the tip end of the extension arm 232 of the supporting beam 230. Since the supporting beam 230 is made of a metallic conductive material and the grounding contact 234 on the supporting beam 230 is electrically connected to the grounding circuit of the circuit board, the static electricity jumped to the supporting beam 230 will be guided by the supporting beam 230 to the grounding circuit on the circuit board, thereby preventing the electronic apparatus or equipment from being affected and damaged by electrostatic discharge.

In this embodiment, the supporting beam 230 has a plurality of interference pieces 236 projecting towards the two sidewalls 212 of the frame 210, and the interference pieces 236 interfere with the sidewalls 212 of the frame 210, thereby retaining the supporting beam 230 on a surface of the frame 210. The supporting beam 230 may further have a cantilever 238 at one edge thereof, and the cantilever 238 has a limiting bump 239 projecting towards the roller mechanism 220, such that the roller mechanism 220 is stopped when moving to the limiting bump 239 of the cantilever 238, i.e. limited, thereby confining a relative movement range of the roller mechanism 220 and the frame 210 and preventing the roller mechanism 220 departing from the frame 210 while moving.

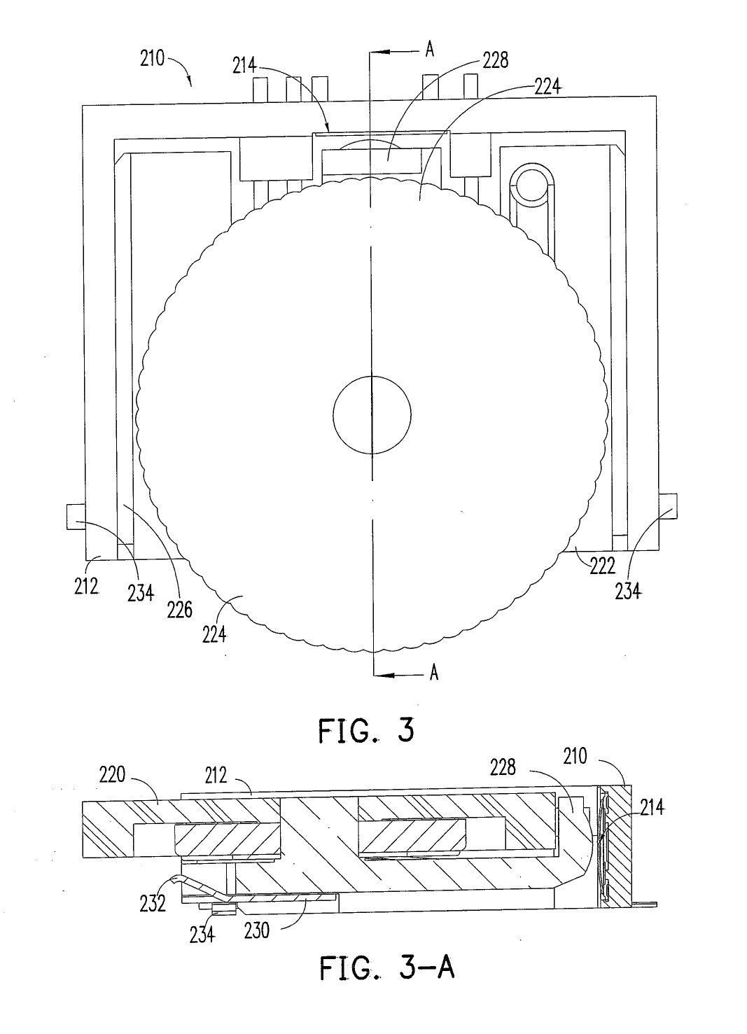

As shown in FIGS. 3 and 3A, in the second embodiment of the present invention, the supporting beam 230 humps up towards the roller mechanism 220, such that the extension arm 232 gets closer to the outer edge of the roller mechanism 220, thus enhancing the effect of attracting static electricity. In this embodiment, a switch 214 can be selectively disposed on the frame 210, and a platen 228 is added on the roller mechanism 220 at an appropriate position corresponding to the switch 214, so that when the roller mechanism 220 and the frame 210 move relative to each other, the platen 228 of the roller mechanism 220 can trigger the switch 214, thereby activating the switch 214 to transmit a signal to the circuit board.

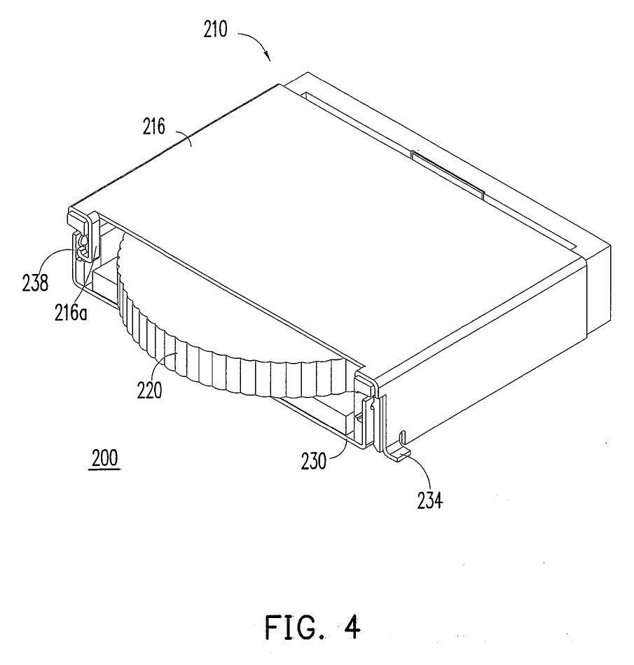

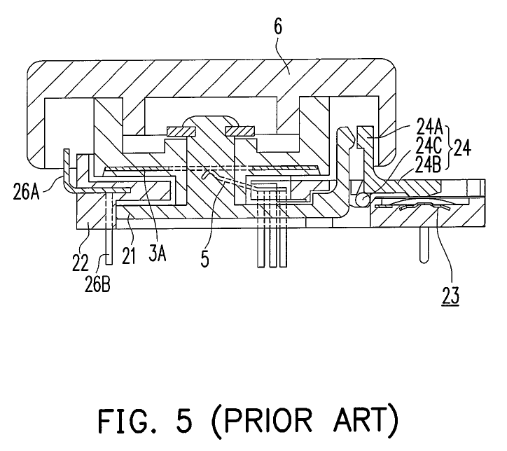

As shown in FIG. 4, in the third embodiment of the present invention, the frame 210 further has a metal shielding case 216, which spans between the two sidewalls 212 of the frame 210. The shielding case 216 not only enhances the mechanical strength of the frame 210, but also forms an electromagnetic shielding for the electronic indicating device and other sensitive electronic devices in the electronic apparatus or equipment, thus avoiding interfering with each other.

In this embodiment, the original grounding contact 234 on the supporting beam 230 in the first embodiment may be formed on the shielding case 216 alternatively, and the shielding case 216 extends to form at least one contact arm 216a to contact the supporting beam 230. As shown in the figure, the contact arm 216a of the shielding case 216 contacts the cantilever 238 of the supporting beam 230, so the supporting beam 230 may be electrically connected to the contact arm 216a of the shielding case 216 through the extension arm 232, and the static electricity is then transmitted to the grounding circuit of the circuit board through the grounding contact 234 of the shielding case 216, thereby forming a path for the supporting beam 230 to indirectly ground the static electricity through the shielding case 216. Only the path for grounding the supporting beam 230 indirectly through another metal conductor is disclosed in the above description. However, those skilled in the art may use other methods which are similar to but not the same as the aforementioned method to electrically connect the supporting beam 230 to the grounding circuit on the circuit board.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrostatic receiving mechanism of an electronic indicating device, suitable for being installed in the electronic indicating device and electrically connected to a grounding circuit of a circuit board, the electrostatic receiving mechanism comprising:
a frame, having two opposite sidewalls, wherein each of the opposite sidewalls has a guide rail;
a roller mechanism, assembled on the frame, wherein the roller mechanism slides relative to the frame through the guide rails of the frame; and
a supporting beam, made of a metallic conductive material, wherein the supporting beam is assembled on the frame and electrically connected to the grounding circuit of the circuit board, the supporting beam has an extension arm, and the extension arm extends towards and close to an outer edge of the roller mechanism.

2. The electrostatic receiving mechanism of an electronic indicating device as claimed in claim 1, wherein the frame is fixed on the circuit board, and the roller mechanism slides within a range confined by the guide rails of the two sidewalls.

3. The electrostatic receiving mechanism of an electronic indicating device as claimed in claim 2, wherein the roller mechanism comprises:
a sliding base, having at least one flange, wherein the sliding base slides relative to the frame within a suitable range by using the flange in conjunction with the frame; and
a roller, rotatably disposed on the sliding base and electrically connected to the circuit board, so that a circuit on the circuit board may sense and determine a rotation of the roller.

4. The electrostatic receiving mechanism of an electronic indicating device as claimed in claim 1, wherein the electrostatic receiving mechanism further comprises a shielding case fixed outside the frame.

5. The electrostatic receiving mechanism of an electronic indicating device as claimed in claim 4, wherein the shielding case is welded with a grounding circuit of the circuit board, and the supporting beam is electrically connected to the shielding case, so that the supporting beam is electrically connected to the grounding circuit through the shielding case.

6. The electrostatic receiving mechanism of an electronic indicating device as claimed in claim 1, wherein the extension arm of the supporting beam is an elastic cantilever.
